(19) United States
(12) Patent Application Publication
(10) Pub. No.: US 2004/0086835 A1
(43) Pub. Date: May 6, 2004

(54) System and method of color-coded fill-in timelines to learn history now

(76) Inventor: Eileen Marie Otto, Brooklyn, NY (US)

Correspondence Address: Eileen M. Otto, 137 88th Street, #3E, Brooklyn, NY, 11209, US

(21) Appl. No.: 10/422,272

(22) Filed: Apr. 24, 2003

Related U.S. Application Data
(60) Provisional application No. 60/375,745, filed on Apr. 26, 2002.

(51) Int. Cl. G09B 19/00

(52) U.S. Cl. 434/154; 434/362

(57) ABSTRACT

A system and method for teaching and learning history and geography which uses color-coded lines that are created, then filled in, by the user with pertinent information about the era or person and area of world being studied. The color-coding for such timelines is based on the breakdown of the historical experience in seven basic categories to which a specific color is then assigned.

### FIELD OF THE INVENTION

The present invention is a system and method of timelines which represent the breakdown of historical experience into seven categories which are then color-coded; these timelines are initially blank and then filled in by user, student or teacher, to learn and teach about a chronology of historical events.

### BACKGROUND OF THE INVENTION

The invention disclosed herein relates to a system and a method for teaching and learning history which uses the breakdown of the historical experience into seven categories which are then assigned a color; the said timelines become an apparatus which the student or teacher fills in, to create a visual associative help-tool which user(s) students use to learn and remember history. It is a structured visual framework consisting of a plurality of lines, specifically seven lines that are color-coded to represent the breakdown of the historical experience into seven basic areas. The student fills in these blank colored timelines that can be constructed by student and teacher, or downloaded from software, for continents or individual countries, and for the period of time that is studied. Multiple users can interactively use color-coded timelines in classroom environment simultaneously for group learning activity, such as a history bee, by using colored chalk, timelines drawn on board and students filling in information about period of time studied.

If colored writing instruments are not available to the user, then a single color, such as a black pen or pencil or white piece of chalk, can be used. The user can still make the seven lines by marking the distinction between the lines as the categories so referenced in Claim 3.

Recent events make it even more imperative for Americans to learn their own history, be familiar with the names and locations of countries of the world, and learn the history of such nations and peoples. Studies show that most students and many Americans have a very inadequate knowledge of history. The present invention provides the heretofore missing history teaching system and method which provides student(s) visually associative, interactive way of learning history, and which is quite inexpensive, easily made and can be used anywhere as it does not required electricity or advanced technology. The current invention can be used by a single user in isolation, such as at home; or, by many users in a classroom environment in collaboration among these many users to share the educational experience.

Many people believe that computers are the answer to almost every learning problem. Computers are nice, however expensive; many schools cannot afford to provide every student access to a computer; most countries, computers in the classroom are not even option. Furthermore, the process of writing words down, filling in the timelines, and constructing the timelines, allows for longer memory retention than simply clicking on a mouse to select an answer choice.

In the current version, the target user is 9 years old to adult. To the best of the investor's knowledge, no such method or system or mechanism is currently commercially available

### DETAILED DESCRIPTION

The system and method for teaching and studying history consists of “to be filled-in” color-coded timelines on which the user tracks information, and which the user either constructs with colored pencils/pens or crayons, or downloads from software, in order to study a chronology of historical events.

The plurality of timelines that are:

not filled in,

to be filled in by the user (student),

total of seven timelines can be used that are color-coded based on the breakdown of the historical experience into seven categories and a color assigned to each category as follows:

Category 1, assigned the color Blue (which then is the Blue timeline):

Civil history, politics, legal system, government, political systems, battles and wars, treaties.

[image]

Category 2, assigned the color Yellow (which then is the Yellow timeline): Philosophy, education, or lack thereof.

[image]

Category 3, assigned the color Pink(which then is the Pink timeline):

The Arts, including Music, Literature, Painting, Dance, Theater.

[image]

Category 4, assigned the color Gold (which then is the Gold timeline):

How people lived—including Architecture, all types of housing and furniture, economics, recreation/sports.

[image]

Category 5, assigned the color Green (which then is the Green timeline):

Sciences & Math, Technology, inventions, medicine.

[image]

Category 6, assigned the color Purple (which then is the Purple timeline):

Religion & spiritual beliefs, mysticism, religious/Church history, spiritual thought.

[image]

Category 7, assigned the color Brown (which then is the Brown timeline):

Nature: the earth, earth changes, natural disasters, weather.

[image]

When using the color-coded timeline system, there can be any single color-colored timeline or number of timelines thereof, with a maximum of seven timelines, used to make the desired timeline schematic.

[image]

The selection of these colors, seven in number, for each category/timeline is the result of the best association the inventor could determine for category of knowledge with a color. An example is the fifth category of science, the ultimate act of science is the process of photosynthesis, which turns the plant green. Purple is a color used by the Churches. Brown is the color of the earth itself. [If someone decides on a different color choice, this patent is still in effect.]

Steps to Using the System and Method:

1. Determine the date [period of time] of the event or person or era involved:

a century, or

centuries, or

decade(s).

2. Determine the geographic locale involved in the period of time to be studied:

the 7 areas/continents of world i.e.,

North America, South America, Europe, Asia, Africa, the Middle East, Australia and the Pacific islands;

or any specific country or group of countries continent and/or,

a specifically defined locale such as a city like New York or London, the Great Lakes area.

3. User [teacher and/or student(s)] determines which color-coded timeline(s) are involved in the study; then proceeds to create the timeline system by either of two ways:

(a) Student or teacher either draws the line(s) [using a ruler or freehand] on paper or blackboard by using a writing implement such as crayons or colored pencils, pens or chalk; or can use colored yarn on a wall if paper is not readily available, OR

(b) downloads from software or CD.

In all cases, the timelines are blank, to be filled in.

5. The student and/or teacher start to fill in the timelines with the information about the historical experience of the time and area of world or personage chosen.

6. This system and method can also be used to study a discipline such as architecture, art, law, or literature:

GEOGRAPHICALLY:

By continent,

By country

By city;

Or, TEMPORALLY:

by centuries

through a period of time, such as the first half of the twentieth century

by decades.

7. The user(s) can further utilize several timelines in the process of studying a chosen period of history, as in Example 2 FIG. 11 on page. By using more than one set of timeliness the user(s) works on several timelines in a vertical manner.

The user(s) can utilize one or more timelines to study a specific discipline, such as architecture, through an extended period of time by following the appropriately colored timeline horizontally through the desired period of time, even through several centuries, for one or more locales.

8. OPTIONAL: the Infinity symbol ∞ can be used as a marker and as a visual navigation tool by placing it on the significant date. The infinity symbol ∞ is used to mark the time and place on the timelines where user begins to study. User can enlarge the Infinity symbol to visually signify a greater period of time that one is studying, encompassing a greater period of time to be studied.—it is a way to visually expand the scope of the era being studied. As the Infinity sign grows larger, the wider the time period studied. [If someone decides to use different colors, the patent is still in effect. The change of colors does not nullify this patent.]

This system and method contains the essentials to learning history—sequence, structure and content in an organized manner so as to contribute to the elimination of confusion and mental overwhelm because there is a visual map of the time and area being studied. This system and method is low tech—it can be used anywhere in the world because it does not require electricity or a computer or any advanced technology other than some writing implement such as crayons because the student/teacher draw the timelines using crayons, colored pencils or pens or colored yarns or colored chalk. This system and method can be adapted to create an educational game. This system and method can assist the user(s) to determine what is fact and what is opinion; by the process of writing on the timelines the facts of the events the user receives a clearer picture of the historical period so that history is not just a “somebody somewhere oppressed somebody else because of racism, this ism or whatever” consciousness that is prevalent among too many professors and teachers in educational circles.

The system and method further utilizes the “5Ws plus how” formula to establish the coordinates of the timelines:

“what” of that which is to be studied;

“who” as those individuals or groups of individuals or nations to be studied;

“when” as the time period [or event or person] to be studied;

“where” as the area of the world;

“why” as experiences/lessons of history are discerned; and, if applicable

“how”, as in the case of a new discovery.

By tracking the details of the historical experience and information on the colored timelines, and thus utilizing uses the “5Ws” formula, i.e., “What, When, Where, Who and Why”, and, if applicable, “How”, this system and method can provide an interface between history and geography

The user picks a significant event and its date. The user can optionally use the Infinity symbol there as a marker and as a visual navigation tool. The user can enlarge the Infinity symbol to mark a greater period of time that user is studying, back and forth in time, encompassing a greater period of time to be studied.

User can use a large map of the area studied (or the world) and a globe. The map gives more detail and the globe gives perspective of placement. A separate map for each continent gives further detail. It is recommended to use a map of the area studied and a globe with the timelines to give more detail and the globe gives perspective of placement on the planet. A separate map for each continent gives further detail.

### OBJECTIVES OF THE INVENTION

There is a Chinese proverb, “Learning is a treasure that follows its owner everywhere”. As for the gross lack of knowledge of history among American students, Americans would be wise to heed the words of Thomas Jefferson, “If a nation expects to be ignorant and free, it expects what never was and never will be.”

An object of the present invention to provide a relatively inexpensive and easily replaceable means for teaching and studying history that utilizes color-coded timelines which the user fills in to learn a chronology of historical events. When the student just sits and does little but listen. [or seems to be listening], the retention of material and the integration of knowledge are minimal. Therefore, it is highly desirable to create a learning system where there is not only educational material but also a means for integrating the material where the retention of knowledge by the user is enhanced and the cost is minimal. With the “fill-in” timelines, the student no longer has to keep everything filed in his/her mind using short-term memory with little no integration or retention. By use of the fill-time colored timelines, the dates are used as moorings or buoys, so that emphasis on memorizing dates is rendered less important because the date has been already identified as a mooring, a buoy or a peg on the timeline.

Briefly, the above and further objects of the present invention are realized by providing a new and improved learning system with an interactive system and method that encourages user participation with historical and educational information. The present invention is interactive: the user can return to the learning system and build on the knowledge gained in previous work by expanding the scope of the timeline(s). The present invention has the potential for use of abundant educational information available from many sources, such as books, historical documents, museums, and learning channels on television. The key is the integration of this information on the colored timelines.

Knowledge requires more than just a wealth of information; to learn from information and gain knowledge, user has to interact with the information, that is, actively probe it, think about it, and organize it into mental models. Active, rather than passive, involvement with a subject leads to greater learning. By providing a hands-on educational system and method for timelines which user can either download or make with writing implement such colored pencils, pens, crayons or chalk, or using colored yarns following said hands-on instructions, and the inputting of requested data onto the said timeliness the processing and retention of available historical information is enhanced. This learning system does not require the immediate presence of an expert or instructor to be substantially effective. It can be used as a self-tutorial. This system and method is very cost effective, requiring only seven crayons, or colored pens or pencils or chalk, and paper; or using colored yarn. If the user(s) lack the seven colored writing implements, whatever can be used to draw a line or make a line, is sufficient and the system and method can still be used effectively.

### DETAILED DESCRIPTION OF CURRENT EMBODIMENT OF INVENTION WITH EXAMPLES AND DRAWINGS

Since the system and method of the color-coded timelines are designed to be filled in by hand, therefore the examples contained herein are done as if by the user.

Steps to Follow for System and Method:

1. The user(s) establishes the time and place to be studied

2. Using this system and method, the user(s) establishes the breakdown of the historical experience into the seven (7) categories;

3. The user(s) then assigns the colors to these seven (7) categories,

4. The user(s) then creates or downloads the desired color-coded, “to be filled in” timelines which are the means to learn about the selected historical period for the selected area of the world. The user can utilize from 1 to 7 color-coded timelines.

5. It is advisable to use a map and/or a globe with this system and method. The globe gives a spatial perspective of where on the planet; the map gives more detail, and a separate map for each country gives further detail.

With the system and method, the user(s) can more easily expand the scope of that which is studied. The system and method provides order and organization, so that the study of history is not just nebulous, random pieces of information.

[image]

[image]

[image]

Using this System and Method:

### EXAMPLE 1

American Revolution

[image]

The “why” and “how” become clear to the user as he/she continues the study the period of history. An important part of this system and method is the filling in of the color-coded timelines with as much pertinent information as the user needs. These “fill-in” timelines are to aid the student learn and retain the knowledge. The user determines what he or she puts on the lines, so that each user will produce a unique colored timelines matrix that suits the individual user's learning needs. This system and method brings the study of History out of the nebulous “somebody somewhere oppressed someone else” ideology that has resulted in a “history illiterate” generation.

### EXAMPLE 2

What was happening in other areas on the planet in 1776, using 3 categories of the Politics [blue line], Thought/Philosophy [yellow line] and The Arts [pink line]:

[image]

[image]

Example of using Infinity symbol as a help to understanding an historical era: Example 3 Battle of Culloden in Scotland. In this example, the blue line and the gold line are used.

By using the optional Infinity symbol, the user can expand the period of time studied before 1776 to see the causes and after 1776 to see the effects on the world. Case in point, the battle of Culloden occurred in 1746. After the battle, many Scots, including women and children, were massacred. Many of the survivors fled to America. By use of the system and method, one can infer that the aftermath of this battle in which the Scottish troops under the Bonnie Prince Charles inadvertently had a tremendous impact on the future of what became America because a large percentage of the soldiers who fought in the American Revolution were of either born in Scotland or first generation Americans from Scottish families who fled British rule in Scotland, as noted on the gold line of “how people lived”. By using the system and method, the user can learn the immediate past of the British monarch the Americans were up against, and the user can gain the understanding that when the 13 colonies declared independence from King George, the Americans knew what their fate would be should they lose the war. The user would learn that the uncle of King George the Third was the infamous Duke of Cumberland, the man responsible for the massacres. This system and method provides for a greater understanding of the era studied without overload as the user fills in the timelines and gains knowledge from an understanding of what preceded the events so as to gain knowledge versus just amassing a series of unrelated pieces of information. Then the user can fully understand why Dr. Benjamin Franklin, who was well aware of the atrocities committed 30 years before in Scotland, stated after the signing of the American Declaration of Independence, “We must hang together or we shall indeed hang separately.” Thus adding the element of “why” to the study of 1776.

EXAMPLE 3

Battle of Culloden in Scotland

[image]

This is just an example of how the colored timelines are used.

[image]

Time: Renaissance period, it began 1400 and lasted until about 1600.

Location: Europe, specifically Netherlands and Italy

Painters: Jan van Eyck; Andrea del Verrocchio; Sandro Botticelli; Leonardo da Vinci; Raphael; Titian; Albrecht Durer and Pieter Bruegel the Elder

Early Renaissance in Flanders, the Netherlands (1400-1500)

High Renaissance in Italy and Netherlands(1495-1600)

[image]

[image]

### EXAMPLE 4 WITH FIG. 13

This timeline system can be used to study a discipline such as Art History, specifically the history of Renaissance oil painting. Example 4, FIG. 13, shows how it is tracked horizontally on one continent for a specific period of time, 1400 through 1600. Example 5, FIG. 14 shows the two specific countries of Europe where there was extensive painting, specifically Italy and the Netherlands or country or countries through a period of time or vertically through a certain century (s) for different areas:

Oil painting through out the Renaissance would be tracked on the pink line and in Europe as in FIG. 13, then specifically Italy and Holland, as in FIG. 14. The student would initially draw or download the single line of pink on which to initially track the period of time and the painters, etc.

[image]

### EXAMPLE 5 FIG. 15

Simultaneously, in England, at there was the reigns of Henry the Eighth and Queen Elizabeth the First; the writing of the Shakespearean plays [actually, end of Renaissance], which would be marked on the pink, although a good argument could be made to place the plays on the yellow so there could be a double line of pink and yellow used as in Example 6, FIG. 16. The death of Sir Thomas More is primarily blue, but the religious aspect of the purple is important, thus there could also be in this case a double line drawn, as in Example 7, FIG. 17, of Martin Luther which began the Protestant Reformation, tracked on FIG. 15.

[image]

[image]

EXAMPLE 6

[image]

This example shows that the colored timelines can contain more than just historical data. Whatever the user deems important can be put on the lines.

EXAMPLE 7

[image]

Example 8, FIG. 18 shows creating timeline matrix with using one line and then adding additional lines for building a complete picture of specified time in history. In this case, the example is Socrates, the user would place information about him on the yellow line for philosophy/thought.

[image]

The Peloponnesian War (431-404 BC) war was during Socrates' life. It was a brutal war fought between the two leading city-states in ancient Greece, Athens and Sparta, and influenced the politics of Athens: this is tracked on the blue line.

[image]

Thus, the user(s) begins to build a matrix of colored-timelines for this period of Greek history. User fills in the information & whatever he/she deems necessary.

[image]

The user(s) can further use the colored timelines to [facilitate] study a particular discipline, in this case, Philosophy [Classical Greek] utilizing the specific colored line, namely yellow. As example, the user could expand the yellow line to include the period from 600 BC to 200 BC, including Pythagoras, Plato, and Aristotle. As the user(s) fills in the timeliness the user is able to learn without overload. And user can have some fun with this system and method. [A larger sheet of paper, or a blackboard in classroom could better accommodate this example.}

[image]

### SUMMARY OF INVENTION

The present invention provides a new and useful system and method for learning history that utilizes a visual schematic of color-coded timelines and is very cost-effective. Included in the system and method is the breakdown the historical experience into seven categories, assigning a color to each category, then either the drawing or downloading of the desires timelines from one line to the full complement of the seven timelines for the time and area of world. These timelines are then filled in by the student or user as part of the learning process for the study of history.

We learn a certain percentage by listening, another percentage by seeing, and a greater percentage by doing—when we combine the three actions—the maximum about of learning occurring. Too much of what we learned in school is lost because of the lack of implementation of the knowledge.

Studies show that many students and many Americans have a very inadequate knowledge of history and geography. Many believe that computers are the answer to almost every learning situation. Computers are nice, however expensive; many schools cannot afford to provide every student access to a computer; most countries, computers in the classroom are not even option. And we cannot afford another generation of “don't know much about history” young people. Furthermore, the process of writing words down, filling in the timeliness and drawing the timelines for those who do not download the lines, allows for longer memory retention than simply clicking on a mouse to select an answer choice. Recent events make it even more imperative for Americans to learn their own history, be familiar with the names and locations of countries of the world, and learn the history of such nations and peoples.

There are many timelines available in bookstores; the difference between this system/method and other timelines is this is a “you fill-in the timelines” system and method of learning of history, not an already filled in-timeline. By filling in the timelines—by writing, the student increases the retention percentage. Each of us learns a certain percentage by listening, another percentage by seeing, and a greater percentage by doing. There is a wonderful Chinese proverb:

I listen and I forget

I see and I learn

I do and I understand.

The acclaimed education innovator, Maria Montessori, observed that the child learns with his/her hands. Each of us possesses a tremendous potential to learn that can be cultivated. Hungarian physicist and mathematician John von Neumann once calculated that over the course of the human lifetime, the brain stores something on the order of 2.8×1020 (280,000,000,000,000,000,000) bits of information. This system and method that brings history [and geography when studied together] out of the nebulous into a “time/space” context with dates and places as the moorings, like buoys of knowledge, so that the student and teacher have perspective of the era studied.

This system and method can assist the user(s) to determine what is fact and what is opinion; the process of writing on the timelines the facts of the events the user(s) receives a clearer picture of the historical period by seeing people and events within the context of their original historical experience which includes the cultural aspects (such as the type of houses they lived in—gold line). Therefore, the student can learn about that era without the nebulous nonsense of “somebody somewhere did something, persecuted someone or whatever”. This system and method renders obsolete the torture of just memorizing dates for tests (most people cram the dates for a midterm or final, then forget the information and the lessons learned). By using this system and method, what the student learns becomes a link in a chain of memory rather than isolated and difficult to retrieve fact because there is a color and a line to help the student understand the events studied, make learning more enjoyable and make learning a lifelong process.

“Learning is a treasure that follows its owner everywhere.” (Chinese proverb)

I claim:

1. A system and method for teaching, studying and learning history that involves:
Determining the time and area of world to be studied;
Breaking down the historical experience into seven basic categories;
Assigning colors to these categories;
Creating the “to be filled in” timelines the filling in of those timelines by the user as a means of studying the selected historical period.

2. A system and method as a means for teaching and studying history that includes:
A plurality of timelines that are:
(a) not filled in, but to be filled in by the student
(b) color-coded based on the breakdown of the historical experience into categories and a color assigned to each category, as referenced in claim 2. Use of any different colors or shading or variation of color or just one color, such as black or white, will not affect this patent.
(c) The timelines are designated according to:
GEOGRAPHY: criteria of continent and/or, country or groups of countries or a specific locale, and,
TIME: for specific period of time such as
a century,
or centuries,
or decade(s), or
Above referenced elements are then used to create a visual tool, which are the color-coded timelines, which the user then utilizes to learn the chronology of historical events by using a combination of the above parameters. If colored writing instruments are not available to the user, the user can use what is available, such as chalk, and still create the lines because the system and method is primarily based on the breakdown of the historical experience.

3. A system and method according to claim 2, as a means for studying and teaching history comprising of steps:
(a) Determining the subject matter and time of said subject matter.
(b) Breaking down the historical matter the user/student is studying into seven categories:
Category 1: Civil history, politics, legal system, government, political systems, battles and wars, treaties,
Category 2: Philosophy, education, or lack thereof,
Category 3 The Arts, including Music, Literature, Painting, Dance, Theater,
Category 4: How people lived: including Architecture, all types of housing and furniture, economics, recreation/sports
Category 5: Sciences & Math, Technology, inventions, medicine
Category 6: Religion & spiritual beliefs, mysticism, religious/Church history, spiritual thought
Category 7: Nature: the earth, earth changes, natural disasters, and the weather.
(c) Assigning a color to each category:
To Category 1: BLUE for Civil history, politics, legal system, government, political systems, battles and wars, treaties.
To Category 2: YELLOW for Philosophy, education, or lack thereof.
To Category 3: PINK for The Arts, including Music, Literature, Painting, Dance, Theater,
To Category 4: GOLD for how people lived: including Architecture, all types of housing and furniture, economics, recreation/sports
To Category 5: GREEN for Sciences & Math, Technology, inventions, medicine
To Category 6: PURPLE for Religion & spiritual beliefs, mysticism, religious/Church history, spiritual thought
To Category 7: BROWN for Nature, the earth, earth changes, natural disasters, the weather
(d) Determining the details of the date [period of time] of the event or person or era involved:
a century, or
centuries, or
decade(s)
(e) Selecting the appropriate category and corresponding color. [Each category, which has been assigned a color, then, becomes a designated line, so that there is the blue line for civil history/government, the yellow line for philosophy and education, pink for the arts].
(f) After having determined the time and locale to be studied, the timelines are constructed/or downloaded for area of the world: the 7 areas/continents of world which are North America, South America, Europe, Asia, Africa, the Middle East, and Australia and the Pacific islands; or any specific country, such as Ireland, or group of countries, such as the Balkans.
(g) Creating the timeline system by either of two ways: after determining which single line (for the chosen category), or number of lines or all seven:
Student or teacher either draws the lines with ruler or free-hand using writing implement such as crayons or colored pencils or pens or chalk, or colored yarns; Or downloads from software or CD, downloading one or more lines up to seven colored lines. In either case, the timelines are blank, awaiting to be filled in. [If someone decides on a different color choice, this patent is still in effect.]
(h) The user (s), student and/or teacher, fills in the timelines with the information about the historical experience of the time and area of world or personage chosen. The timelines are meant to be used as a system and method for studying, learning and teaching. The user(s) determines what information and markings are put on timelines.
(i) As an option, the Infinity symbol is used as a marker and as a visual navigation tool by placing it on the significant date. One enlarges the Infinity symbol to signify a greater period of time that one is studying, back and forth in time, encompassing a greater period of time to be studied.

4. A system and method, according to claim 3, that is a structured visual framework, that can be used to study a specific discipline such as architecture, (the gold line), or law (blue line), or painting (pink) horizontally on one continent or country through an extended period of time such as several centuries, or Vertically through a chosen period of time (decade(s) or century(s) for several locales. The timelines can be broken down geographically by continent and by country; temporally by century, by decade(s); or by combinations as needed.

5. A system and method, according to claim 3, that provides sequence, structure and content to the action of studying or teaching history that: allows for concentration in a particular period and place in history in an organized manner, or allows for a general overview of large periods of time and many places in an organized manner by utilizing many timelines simultaneously or as the user so determines.

6. A system and method that can be used anywhere in the world because it does not require electricity or a computer or any advanced technology other than some writing implement such as crayons, and the user(s) can utilize whatever material such as books, encyclopedia, oral tradition is available.

7. A system and method for learning, study tool studying and teaching history that can be used as an individualized study tool. The user(s) determines what information and markings are put on timelines.

8. A system and method, according to claim 3, that optionally uses the Infinity symbol to mark the time and place on the timelines where user begins to study. The Infinity Symbol can be expanded by user to denote greater period of time included in the study of history.

8. A system and method for teaching, studying and learning history, according to claim 1, that additionally can be utilized for the study of geography by utilizing a map and/or globe with the timelines on which the user(s) writ with appropriate information about the area of world the user(s) is teaching or studying.

9. A system and method for teaching, studying and learning history, according to claim 3, in which a combination of two lines can be utilized by user(s) for areas of study that are of a more advanced nature. In such cases, the following double color-coded timelines, though not limited to these alone, can be used:
BLUE/YELLOW: for Law Or Jurisprudence
PINK/YELLOW: for great Literature, such as the Shakespearean plays
PURPLE/YELLOW: for Religious Philosophy
